(19) United States
(12) Patent Application Publication
(10) Pub. No.: US 2013/0266364 A1
(43) Pub. Date: Oct. 10, 2013

(54) Pole Adapter for Tool Heads

(71) Applicant: Soares Andrew John, Oakdale, CA (US)

(72) Inventor: Soares Andrew John, Oakdale, CA (US)

(21) Appl. No.: 13/443,836

(22) Filed: Apr. 10, 2012

(51) Int. Cl. B25G 3/30

(52) U.S. Cl. 403/299

(57) ABSTRACT

A pole adapter comprises a body comprising a generally cylindrical shape comprising a first end, a second end, a threaded portion being disposed proximate the first end, and an attachment portion being disposed proximate the second end. The threaded portion is configured for threadably joining to at least one of a plurality threaded tool heads. The attachment portion is configured for joining to a pole, in which a chosen tool head may be operated from a distal portion of the pole.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to household tools. More particularly, one or more embodiments of the invention relate to a pole adapter.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. In general, nearly every home has maintenance needs. In some instances, a homeowner may not have means for reaching high areas such as, but not limited to, windows, eaves or awnings to perform maintenance tasks including, without limitation, cleaning, removing cobwebs, dusting, painting, etc. Ladders are often used to reach high areas. However, some homeowners may not have access to a ladder or the physical ability to use a ladder. Moreover, it is believed that climbing a ladder may sometimes be an ineffective or unsafe means for reaching high places. Furthermore, one may expect that the improper use of a ladder may result in injury.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A through 1D illustrate an exemplary pole adapter, in accordance with an embodiment of the preset invention. FIG. 1A is a side perspective view of the adapter. FIG. 1B is a cross sectional side view of a body of the adapter. FIG. 1C is a diagrammatic side view of the body, and FIG. 1D is a side perspective view of a detent lock ball attachment of the adapter; and

FIG. 2 illustrates an exemplary pole adapter in use on a swimming pool pole, in accordance with an embodiment of the present invention.

Unless otherwise indicated illustrations in the figures are not necessarily drawn to scale.

### DETAILED DESCRIPTION OF SOME EMBODIMENTS

Embodiments of the present invention are best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

One embodiment of the present invention provides an adapter that generally enables a swimming pool pole to be used as a high reach tool. In many embodiments, the adapter is a device that provides means for attaching to a pool pole and means for accepting a slide on or threaded head. Many embodiments enable common threaded and slide on heads such as, but not limited to, brooms, squeegees, dusters, cobweb dusters, paint rollers, light bulb changers, etc. to attach to a swimming pool pole. Since one may expect that most people who have a swimming pool also have a pool pole for skimming out leaves, it is believed that many individuals already own a pool pole. Using some embodiments of the present invention, these same poles may be used to reach high areas from the ground for many home tasks including, without limitation, cleaning windows, dusting off awnings, cleaning cobwebs, hanging Christmas lights, cleaning ceiling fans, changing light bulbs, painting, etc.

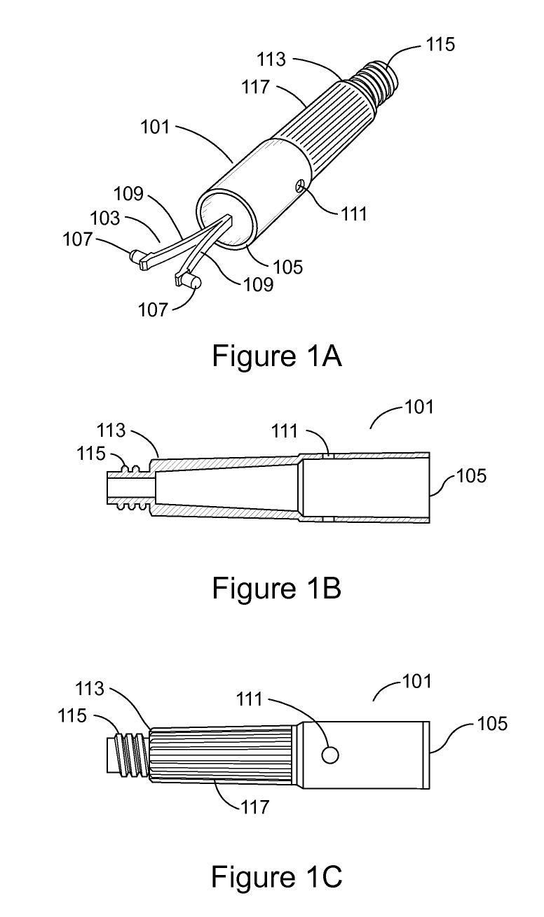

FIGS. 1A through 1D illustrate an exemplary pole adapter, in accordance with an embodiment of the preset invention. FIG. 1A is a side perspective view of the adapter. FIG. 1B is a cross sectional side view of a body 101 of the adapter. FIG. 1C is a diagrammatic side view of body 101, and FIG. 1D is a side perspective view of a detent lock ball attachment 103 of the adapter. In the present embodiment, the adapter is a simple tool that attaches to a swimming pool pole for the purpose of attaching and utilizing other tool heads, typically cleaning heads such as, but not limited to, squeegees, dusters, light bulb changers, brooms, etc. The adapter comprises body 101 and detent lock ball attachment 103 the provides means for engaging the pool pole. In the present embodiment, body 101 is approximately 5 inches in length and formed from molded plastic. Those skilled in the art will readily recognize, in light of and in accordance with the teachings of the present invention, that some alternate embodiments may be made in any suitable size and from any suitable material such as, but not limited to, various different metals.

In the present embodiment, an attachment end 105 of body 101 is the end that slides into a pool pole. Attachment end 105 is approximately 1.5 inches in diameter to fit into most standard pool poles. It is contemplated that the attachment ends of some alternate embodiments may be larger or smaller in diameter to fit poles of varying sizes. Referring to FIGS. 1A and 1D, in the present embodiment, detent lock ball attachment 103 comprises two detent lock balls 107 on the ends of two plates 109 in a V-shaped configuration that attach and secure the adapter to a pool pole. When detent lock ball attachment 103 is inserted into body 101, plates 109 flex inward slightly to fit into body 101 and provide outward pressure to generally enable lock balls 107 to fit into and remain in place in apertures 111 in body 101. In general, pool poles comprise means for accepting detent lock ball attachment 103. Therefore, the adapter is typically able to slide into a pool pole, and lock balls 107 click into place within the pool pole to hold the adapter in position. In some alternate embodiments, locking mechanisms of any suitable shape may be used in place of V-shaped mechanism 103, shown by way of example in the present embodiment. Referring to FIGS. 1A through 1C, in the present embodiment, the adapter comprise a tapered end 113 designed to accept most slide on heads such as, but not limited to, window squeegees and some brooms. Tapered end 113 also comprises a threaded pattern 115 that fits most common household threaded heads, for example, without limitation, dusters, paint rollers, brooms, light bulb changers, cobweb dusters, window cleaning tools, etc. It is contemplated that some alternate embodiments may be implemented with a tapered end without a threaded pattern, and other alternate embodiments may be implemented with a non-tapered yet threaded end. Referring to FIGS. 1A and 1C, in the present embodiment, a center portion 117 of body 101 comprises a textured finish to generally provide added grip for a user when installing the adapter to a pool pole and when attaching and removing heads from the adaptor. It is contemplated that some alternate embodiments may comprise a multiplicity of suitable textures including, without limitation, knurled textures, cross-hatched textures, smooth textures, etc. Other alternate embodiments may be implemented with rubberized coatings to provided added grip.

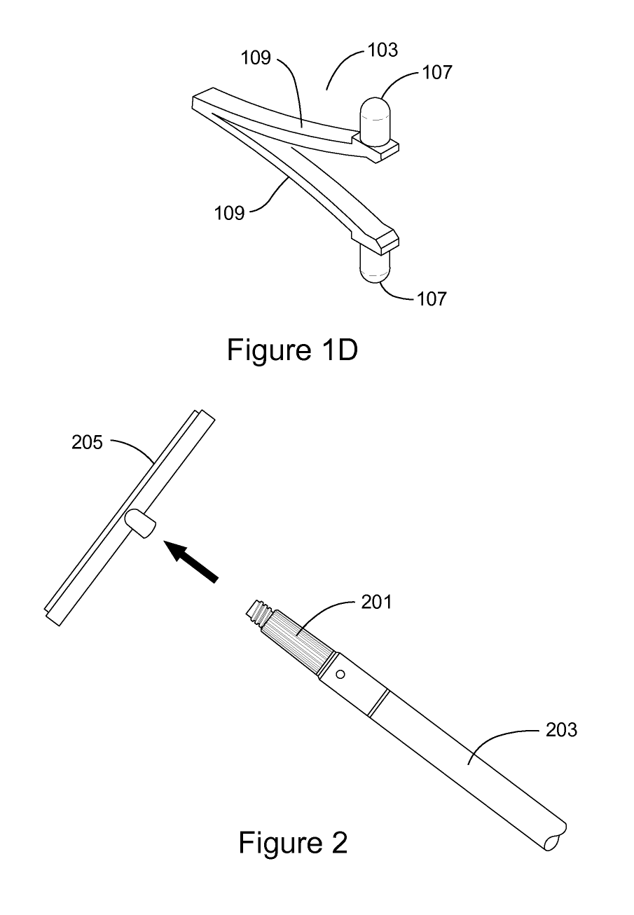

FIG. 2 illustrates an exemplary pole adapter 201 in use on a swimming pool pole 203, in accordance with an embodiment of the present invention. In typical use of the present embodiment, adapter 201 typically attaches to swimming pool pole 203 for the purpose of attaching and utilizing a tool head 205. In the present example, head 205 is a squeegee. However, any suitable tool head may be attached to adapter 201 including, without limitation, duster heads, light bulb changers, broom heads, paint rollers, etc. Adapter 201 snaps onto the end of pool pole 203 with a detent lock attachment and tool head 205 may be slipped or threaded onto the tapered end of adapter 201. Adapter 201 integrates the reach function of pool pole 203 with the function of tool head 205 to generally enable a user to use tool head 205 on an area that is out of reach by adapting the connection between pool pole 203 and tool head 205. Those skilled in the art will readily recognize, in light of and in accordance with the teachings of the present invention, that adapters in some alternate embodiments may be made by combining any suitable connection type including, without limitation, pins, magnets, or clamps, with a detent lock connection, which is used on most pool poles. In the present embodiment, adapter 201 generally enables a user to safely reach hard to reach high places without using a ladder. In addition adapter 201 may be a low cost solution verses buying a separate high reach pole or a ladder.

It is contemplated that some alternate embodiments may be used with non-household heads such as, but not limited to, tree trimming tools, heads for washing vehicles, fruit picking tools, etc. In addition some alternate embodiments may comprise a multiplicity of suitable accessories and features including, without limitation, lights or an ergonomic shape.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of providing a pole adapter according to the present invention will be apparent to those skilled in the art. The invention has been described above by way of illustration, and the specific embodiments disclosed are not intended to limit the invention to the particular forms disclosed. For example, the particular implementation of the adapter may vary depending upon the particular type of heads being used. The adapters described in the foregoing were directed to implementations for the use of a single head; however, similar techniques are to provide adapters to which multiple heads may be attached. For example, without limitation, one alternate embodiment may comprise two tapered and/or threaded tips in a Y or T shape at the end of the adaptor. This embodiment may be useful for example, without limitation, for attaching a mop head and a squeegee head to generally enable a user to wash and dry an area without changing heads. Implementations of the present invention that can hold multiple heads are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. A pole adapter comprising:
a body comprising a generally cylindrical shape comprising a first end, a second end, a threaded portion being disposed proximate said first end, and an attachment portion being disposed proximate said second end, said threaded portion being configured for threadably joining to at least one of a plurality threaded tool heads, said attachment portion being configured for joining to a pole, in which a chosen tool head may be operated from a distal portion of the pole.

2. The pole adapter as recited in claim 1, further comprising a tapered portion extending from a proximal end of said threaded portion, said tapered portion being configured for slidably joining to at least one of a plurality of slide on tool heads.

3. The pole adapter as recited in claim 1, in which said attachment portion is further configured to slide into a standard pool pole.

4. The pole adapter as recited in claim 3, in which said attachment portion further comprises a substantially hollow cavity and at least two opposing holes entering said cavity through a surface of said attachment portion.

5. The pole adapter as recited in claim 4, further comprising a lock ball mechanism being configured to protrude through said opposing holes for engaging the standard pool pole.

6. The pole adapter as recited in claim 5, in which said lock ball mechanism further comprises detent lock balls on ends of two plates in a v-shaped configuration.

7. The pole adapter as recited in claim 6, in which said detent lock ball are configured to engage apertures in the standard pool pole.

8. The pole adapter as recited in claim 2, in which said tapered portion further comprises a generally truncated cone.

9. The pole adapter as recited in claim 2, in which said tapered portion further comprises a textured finish for gripping during joining.

10. The pole adapter as recited in claim 9, in which said textured finish comprises raised structures.

11. The pole adapter as recited in claim 1, in which said threaded portion further comprises a male thread pattern.

12. The pole adapter as recited in claim 1, in which the tool heads comprise household cleaning tools.

13. A pool pole adapter comprising:
a body comprising a generally cylindrical shape comprising a first end, a second end, means being configured for threadably joining to at least one of a plurality threaded tool heads, said means for threadably joining being disposed proximate said first end, and means being configured for joining to a standard pool pole, said means for joining being disposed proximate said second end, in which a chosen tool head may be operated from a distal portion of the pole.

14. The pool pole adapter as recited in claim 13, further comprising means being configured for slidably joining to at least one of a plurality of slide on tool heads, said means for slidably joining extending from a proximal end of said threaded portion.

15. The pool pole adapter as recited in claim 13, further comprising means being configured for engaging apertures in the standard pool pole.

16. A pool pole adapter comprising:
a body comprising a generally cylindrical shape comprising a first end, a second end, a threaded portion being disposed proximate said first end, a tapered portion extending from a proximal end of said threaded portion, and an attachment portion being disposed proximate said second end, said threaded portion being configured for threadably joining to at least one of a plurality threaded tool heads, said tapered portion being configured for slidably joining to at least one of a plurality of slide on tool heads, said tapered portion further comprising a generally truncated cone, said attachment portion being configured for joining to a standard pool pole by sliding into the standard pool pole, said attachment portion further comprising a substantially hollow cavity and at least two opposing holes entering said cavity through a surface of said attachment portion; and
a lock ball mechanism being configured to protrude through said opposing holes for engaging the standard pool pole, said lock ball mechanism further comprises detent lock balls on ends of two plates in a v-shaped configuration, said detent lock ball being configured to engage apertures in the standard pool pole, in which a chosen tool head may be operated from a distal portion of the standard pool pole.

17. The pool pole adapter as recited in claim 16, in which said tapered portion further comprises a textured finish for gripping during joining.

18. The pool pole adapter as recited in claim 17, in which said textured finish comprises raised structures.

19. The pool pole adapter as recited in claim 16, in which said threaded portion further comprises a male thread pattern.

20. The pool pole adapter as recited in claim 16, in which the tool heads comprise household cleaning tools.
